(19) United States
(12) Patent Application Publication
(10) Pub. No.: US 2026/0061848 A1
(43) Pub. Date: Mar. 5, 2026

(54) VEHICLE CONTROL APPARATUS

(71) Applicant: SUBARU CORPORATION, Tokyo (JP)

(72) Inventors: Tomoya TAKEUCHI, Tokyo (JP); Kyohei ABE, Tokyo (JP); Daisuke KATO, Tokyo (JP); Keisuke OKAZAKI, Tokyo (JP); Satoshi HISAMOTO, Tokyo (JP); Shogo HIRATA, Tokyo (JP); Yuji AKIMOTO, Tokyo (JP); Taisei NAKAYAMA, Tokyo (JP)

(21) Appl. No.: 19/264,957

(22) Filed: Jul. 10, 2025

(30) Foreign Application Priority Data
Aug. 30, 2024 (JP) 2024-148076

(51) Int. Cl. B60L 1/00; B60L 50/60

(52) U.S. Cl. CPC B60L 1/003; B60L 50/60; B60L 2210/10; B60L 2210/40; B60L 2240/34

(57) ABSTRACT

A vehicle control apparatus includes a control processor including: a necessary-electric-power-amount calculator calculating a necessary electric power amount that is a sum of an electric power amount suppliable to a first battery and an electric power amount necessary to activate an in-vehicle device; an operation state determiner determining a state of operation of the in-vehicle device; and a switching processor controlling a switchover of a destination of external electric power between the first battery and a second battery. The control processor supplies the external electric power to the first battery, based on the necessary electric power amount, and when the in-vehicle device is switched from an operation state to a non-operation state while the first battery is being supplied with the external electric power, supplies an electric power amount equal to the electric power amount necessary to activate the in-vehicle device, from the external electric power to the second battery.

### CROSS-REFERENCE TO RELATED APPLICATIONS

The present application claims priority from Japanese Patent Application No. 2024-148076 filed on Aug. 30, 2024, the entire contents of which are hereby incorporated by reference.

### BACKGROUND

The disclosure relates to a vehicle control apparatus.

Recently, an electric vehicle that drives a traveling motor with electric power supplied from a chargeable and dischargeable secondary battery has drawn worldwide attention from a viewpoint of sustainable development goals (SDGs).

Such an electric vehicle is provided with an in-vehicle electric device such as an air conditioner that conditions the air inside a vehicle compartment. The in-vehicle device is supplied with driving electric power from the same battery that supplies electric power to the traveling motor.

Accordingly, frequent use of the in-vehicle device, such as an air conditioner, that consumes a large amount of electric power during the travel of the electric vehicle can reduce a travel distance of the electric vehicle.

To address this concern, Japanese Unexamined Patent Application Publication No. 2001-63347, for example, discloses pre-air-conditioning that cools or warms the inside of a vehicle compartment in advance by activating an air conditioner with an excess output from a charger during battery charging performed while an electric vehicle is stopped from traveling.

Such pre-air-conditioning that adjusts the temperature inside the vehicle compartment before the electric vehicle starts traveling helps to reduce the amount of electric power to be consumed by the air conditioner after the electric vehicle starts traveling, include the travel distance of the electric vehicle, and allow a driver to board the electric vehicle after the temperature inside the vehicle compartment is adjusted to an appropriate temperature.

### SUMMARY

An aspect of the disclosure provides a vehicle control apparatus including a switcher and a control processor. The switcher is configured to make a switchover of a destination to be supplied with external electric power between a first battery and a second battery. The control processor includes a necessary-electric-power-amount calculator, an operation state determiner, and a switching processor. The necessary-electric-power-amount calculator is configured to, when the external electric power is to be supplied to the destination, calculate a necessary electric power amount that is a sum total of an amount of electric power suppliable to the first battery and an amount of electric power necessary to activate an in-vehicle device. The operation state determiner is configured to determine a state of operation of the in-vehicle device. The switching processor is configured to control the switchover to be made by the switcher. The control processor is configured to supply the external electric power to the first battery, based on the necessary electric power amount. When the in-vehicle device is switched from an operation state to a non-operation state while the first battery is being supplied with the external electric power, the control processor is configured to control the switcher and supply an amount of electric power that is equal to the amount of electric power necessary to activate the in-vehicle device from the external electric power to the second battery.

An aspect of the disclosure provides a vehicle control apparatus including a first battery, a second battery, a switcher, and a control processor. The switcher is configured to make a switchover of a destination to be supplied with external electric power between the first battery and the second battery. The control processor includes one or more processors, and one or more memories communicably coupled to the one or more processors. The one or more processors are configured to, when the external electric power is to be supplied to the destination, calculate a necessary electric power amount that is a sum total of an amount of electric power suppliable to the first battery and an amount of electric power necessary to activate an in-vehicle device, and supply the external electric power to the first battery, based on the necessary electric power amount. When the in-vehicle device is activated and switched from an operation state to a non-operation state while the first battery is being supplied with the external electric power, the one or more processors are configured to control the switcher and supply an amount of electric power that is equal to the amount of electric power necessary to activate the in-vehicle device from the external electric power to the second battery.

An aspect of the disclosure provides a vehicle control apparatus including a switcher and circuitry. The switcher is configured to make a switchover of a destination to be supplied with external electric power between a first battery and a second battery. The circuitry is configured to, when the external electric power is to be supplied to the destination, calculate a necessary electric power amount that is a sum total of an amount of electric power suppliable to the first battery and an amount of electric power necessary to activate an in-vehicle device, determine a state of operation of the in-vehicle device, control the switchover to be made by the switcher, supply the external electric power to the first battery, based on the necessary electric power amount, and when the in-vehicle device is switched from an operation state to a non-operation state while the first battery is being supplied with the external electric power, control the switcher and supply an amount of electric power that is equal to the amount of electric power necessary to activate the in-vehicle device, from the external electric power to the second battery.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1 is a block diagram illustrating an exemplary configuration of a vehicle control apparatus according to one example embodiment of the disclosure.

FIG. 2 is a block diagram illustrating an exemplary configuration of a control processor in the vehicle control apparatus illustrated in FIG. 1.

FIG. 3 is a flowchart of processing to be performed by the control processor in the vehicle control apparatus illustrated in FIG. 1.

FIG. 4 is a diagram illustrating the amount of electric power to be supplied to a battery in the vehicle control apparatus illustrated in FIG. 1 in a chronological order.

FIG. 5 is a diagram illustrating the amount of electric power to be supplied to the battery in the vehicle control apparatus illustrated in FIG. 1 in a chronological order.

### DETAILED DESCRIPTION

The amount of electric power suppliable to a battery keeps fluctuating depending on temperature conditions. A battery supplied with electric power in an amount greater than an acceptable amount can cause a breakage of a component of a vehicle.

Representative factors that make the electric power consumption indeterminate include an in-vehicle device, such as an air conditioner, that consumes a large amount of electric power.

For example, when the in-vehicle device such as an air conditioner is repeatedly switched from an ON state to an OFF state by an occupant of the vehicle while the battery is being charged, the electric power consumption can largely fluctuate prior to execution of control processing by an ECU.

When the amount of electric power suppliable to the battery is 10 KW and the electric power consumption of the in-vehicle device such as an air conditioner is 1.5 kW, for example, it is desirable to supply electric power of 11.5 kW from an external power source to the battery via a charger, from a viewpoint of charging efficiency.

However, if the in-vehicle device such as an air conditioner is switched by the occupant from the ON state to the OFF state while the battery is being charged, the amount of electric power of 11.5 kW, which is greater than the acceptable electric power amount of the battery, can be supplied to the battery, resulting in a breakage of a component of the vehicle.

To address this concern, a method of reducing the amount of electric power to be supplied to the battery has been put to a practical use. According to the method, the amount of electric power to be supplied to the battery is set equal to the amount of electric power suppliable to the battery. This helps to prevent the battery from being supplied with the amount of electric power greater than the amount of electric power suppliable to the battery, even if the in-vehicle device such as an air conditioner is repeatedly switched by the occupant from the ON state to the OFF state.

However, this method can decrease efficiency of charging the battery, resulting in an extended charging time.

It is desirable to provide a vehicle control apparatus that supplies a battery with a maximum amount of electric power suppliable to the battery, despite a fluctuation of an electric power consumption of an in-vehicle device.

### Example Embodiment

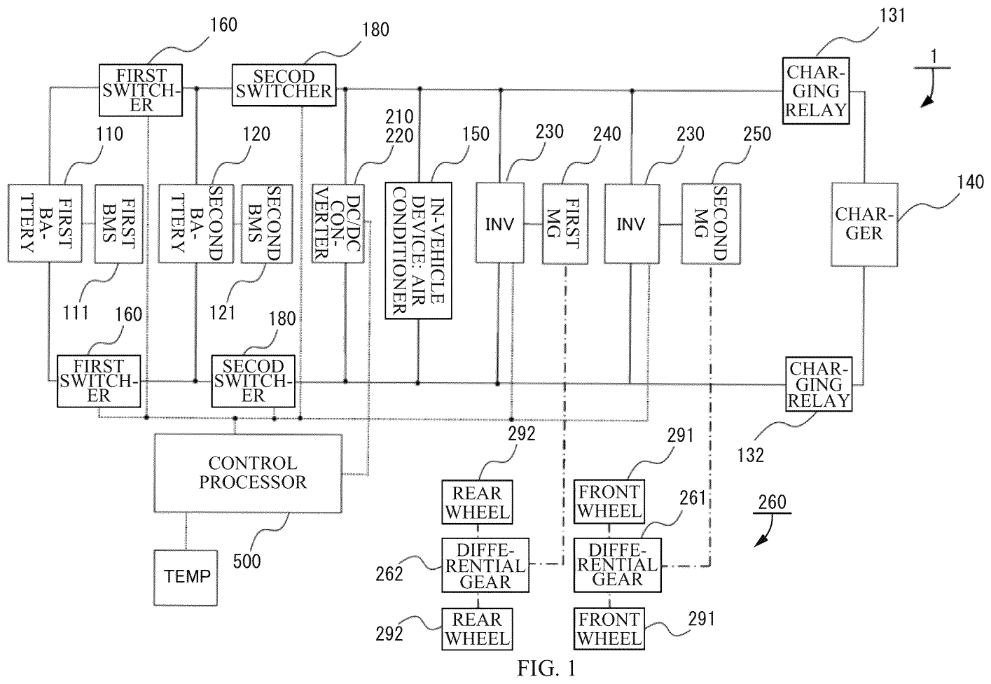

A description will be given, with reference to FIGS. 1 to 5, of a vehicle control apparatus 1 of an example embodiment.

### <Configuration of Vehicle Control Apparatus 1>

As illustrated in FIG. 1, the vehicle control apparatus 1 according to the present example embodiment may include a first battery 110, a first battery management system (BMS) 111, a second battery 120, a second BMS 121, charging relays 131 and 132, a charger 140, an in-vehicle device 150, a first switcher 160, a second switcher 180, a first DC/DC converter 210, a second DC/DC converter 220, an inverter (INV) 230, a first motor generator (MG) 240, a second motor generator (MG) 250, differential gears 261 and 262, a front wheel 291, a rear wheel 292, and a control processor 500.

The first battery 110 may be a chargeable and dischargeable secondary battery.

In some embodiments, the first battery 110 may be a storage battery such as a lithium-ion battery, and may serve as a battery that supplies electric power to a drive system of the vehicle.

The first BMS 111 may monitor and control the state of the first battery 110 in units of cells in the first battery 110 for safe and long-term use of the first battery 110.

In some embodiments, the first BMS 111 may be configured to measure a voltage of each battery cell in the first battery 110 or a voltage of an entire battery pack of the first battery 110, to thereby prevent the first battery 110 from being over-charged or over-discharged.

In some embodiments, the first BMS 111 may be configured to measure a discharge current from each battery cell in the first battery 110 and a charging current to the first battery 110, and check the state of use and the state of charge of the first battery 110, to thereby perform appropriate control of the first battery 110.

In some embodiments, the first BMS 111 may be configured to constantly monitor a temperature of each battery cell in the first battery 110 with a temperature sensor, and operate the first battery 110 within an appropriate temperature range, to thereby secure safety of the first battery 110 and extended service life of the first battery 110.

The second battery 120 may be a chargeable and dischargeable secondary battery.

In some embodiments, the second battery 120 may be a storage battery such as a lithium-ion battery, and may serve as a battery that supplies electric power to devices mounted in the vehicle, such as the in-vehicle device 150.

The second BMS 121 may monitor and control the state of the second battery 120 in units of cells in the second battery 120 for safe and long-term use of the second battery 120.

Note that the second BMS 121 may be configured similarly to the first BMS 111, and a detailed description thereof is thus not given herein.

To charge the first battery 110 or the second battery 120, the charger 140 may convert alternating current (AC) power received from a power source such as a rapid charger into direct current (DC) power, and supply the DC power to the first battery 110 or the second battery 120.

In the present example embodiment, the charger 140 may be coupled to the first battery 110 via the first switcher 160 to be described later, and to the first DC/DC converter 210 to be described later.

The in-vehicle device 150 may be operated by the electric power held in the vehicle.

In the present example embodiment, the in-vehicle device 150 may be a device that consumes a large amount of electric power, such as an air conditioner.

Note that, although the present example embodiment will be described below by taking the air conditioner as an example of the in-vehicle device 150, the in-vehicle device 150 may be another device, such as a heater, that consumes a large amount of electric power than the air conditioner.

The first switcher 160 may be an element that switches the first battery 110 and the charger 140 between a coupled state and a decoupled state. In some embodiments, the first switcher 160 may be a high-voltage relay.

The state of operation of the first switcher 160 may be controlled in accordance with a control signal from the control processor 500 to be described later.

In the present example embodiment, the first switcher 160 may switch from a non-contact state that is an open state to a contact state that is a closed state upon a start of charging the first battery 110.

The second switcher 180 may be an element that switches the second battery 120 and the charger 140 between a coupled state and a decoupled state. In some embodiments, the second switcher 180 may be a high-voltage relay.

The state of operation of the second switcher 180 may be controlled in accordance with a control signal from the control processor 500 to be described later.

In the present example embodiment, the second switcher 180 may switch from a non-contact state that is an open state to a contact state that is a closed state upon a transition of the charger 140 from an operation state to a non-operation state.

In some embodiments, the first DC/DC converter 210 may be a non-isolated bidirectional DC/DC converter.

The first DC/DC converter 210 may include multiple switching elements.

The first DC/DC converter 210 may include a reference path coupled to both a negative side of the first battery 110 and a negative side of the inverter 230 to be described later, a high-voltage path coupled to a positive side of the inverter 230, and a low-voltage path coupled to a positive side of the first battery 110.

The second DC/DC converter 220 may include a reference path coupled to both a negative side of the second battery 120 and the negative side of the inverter 230 to be described later, a high-voltage path coupled to the positive side of the inverter 230, and a low-voltage path coupled to a positive side of the second battery 120.

The in-vehicle device 150 may be coupled to between the second DC/DC converter 220 and the second switcher 180, and have a negative side coupled to a reference path and a positive side coupled to a low-voltage path.

The inverter 230 may convert DC power received from the first DC/DC converter 210 or the second DC/DC converter 220 into AC power by changing the frequency and voltage of the DC power, and supply the AC power to the first motor generator 240 and the second motor generator 250, based on a control signal from the control processor 500 to be described later.

In the present example embodiment, the AC power supplied via the charger 140 may be supplied to the second battery 120 via the first DC/DC converter 210, the second DC/DC converter 220, and the inverter 230 when the second switcher 180 is brought into the coupled state. As a result, the second battery 120 may be charged.

The first motor generator 240 may be an integrated device serving both as a starter that starts up an engine and an alternator that generates electric power.

The first motor generator 240 may achieve a wide range of driving technologies including idle reduction, engine assistance in traveling, and energy regeneration upon decelerating, to thereby contribute to enhancement of power efficiency.

The first motor generator 240 may contribute to improved vehicle mountability owing to the integration of mechanical and electrical components, quiet start owing to belt driving, quick restart and high-engine-speed assistance owing to control technology, highly efficient power generation owing to winding technology, and noise reduction.

Note that the second motor generator 250 may have functionalities and advantages similar to those of the first motor generator 240, and a detailed description thereof is thus not given herein.

A power transmission mechanism 260 may include components such as a decelerator and a transmission.

The differential gears 261 and 262 may absorb a difference in speed between an inner wheel and an outer wheel of the vehicle.

The first motor generator 240 and the second motor generator 250 may each have an output shaft coupled to the power transmission mechanism 260.

The power transmission mechanism 260 may have an output shaft coupled to the differential gears 261 and 262. The second motor generator 250 may transmit a driving force to an axel via the differential gear 261, to thereby drive the front wheel 291. The first motor generator 240 may transmit a driving force to the axel via the differential gear 262, to thereby drive the rear wheel 292.

The control processor 500 may control an overall operation of the vehicle control apparatus 1 of the present example embodiment, based on a control program held in a memory such as a read only memory (RAM) or a random-access memory (RAM) in a non-illustrated storage.

In some embodiments, the control processor 500 may operate the first switcher 160 to switch the first battery 110 and the charger 140 to the coupled state or the decoupled state when a predetermined condition is satisfied.

In some embodiments, the control processor 500 may operate the second switcher 180 to switch the second battery 120 and the charger 140 to the coupled state or the decoupled state when a predetermined condition is satisfied.

### <Control Processor 500>

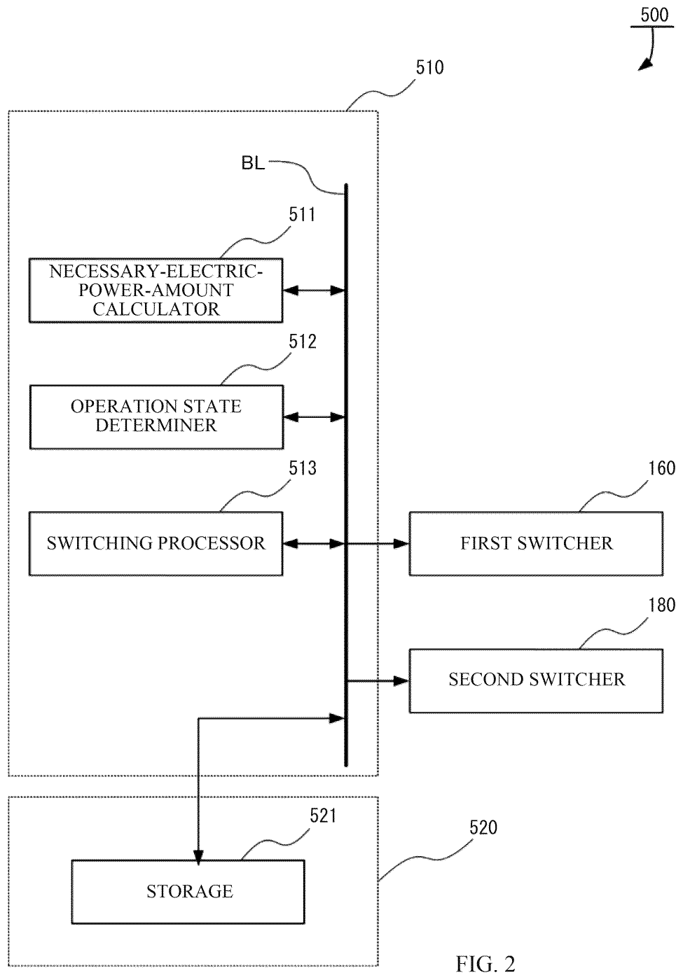

As illustrated in FIG. 2, the control processor 500 of the present example embodiment includes a processor 510 and a memory 520.

In the present example embodiment, when external electric power is to be supplied via the charger 140, the processor 510 calculates a necessary electric power amount that is a sum total of the amount of electric power suppliable to the first battery 110 and the amount of electric power necessary to activate the in-vehicle device 150, and supplies the external electric power to the first battery 110, based on the necessary electric power amount. When the in-vehicle device 150 is switched from an operation state to a non-operation state while the first battery 110 is being supplied with the external electric power via the charger 140, the processor 510 supplies an amount of electric power that is equal to the amount of electric power necessary to activate the in-vehicle device 150 to the second battery 120.

The memory 520 may include a ROM or RAM in which programs and various kinds of data are recorded and stored.

The memory 520 may include a storage 521 in which data, such as a condition for the processor 510 to supply the amount of electric power that is equal to the amount of electric power necessary to activate the in-vehicle device 150 to the second battery 120, is recorded and stored.

### <Configuration of Processor 510>

As illustrated in FIG. 2, the processor 510 in the vehicle control apparatus 1 of the present example embodiment may include a necessary-electric-power-amount calculator 511, an operation state determiner 512, and a switching processor 513.

As illustrated in FIG. 2, the necessary-electric-power-amount calculator 511, the operation state determiner 512, the switching processor 513, and the memory 520 may be coupled to each other by a bus line BL.

When the external electric power is to be supplied via the charger 140, the necessary-electric-power-amount calculator 511 calculates the necessary electric power amount that is the sum total of the amount of electric power suppliable to the first battery 110 and the amount of electric power necessary to activate the in-vehicle device 150.

A result of the calculation obtained by the necessary-electric-power-amount calculator 511 may be transmitted to the switching processor 513 via the bus line BL.

The operation state determiner 512 may determine a state of operation of the in-vehicle device 150.

A result of the determination made by the operation state determiner 512 may be transmitted to the switching processor 513 via the bus line BL.

The switching processor 513 may perform switching control of the first switcher 160 and the second switcher 180.

In the present example embodiment, the switching processor 513 may be a single switching processor that controls charging of each of the first battery 110 and the second battery 120 by performing ON/OFF operations so as not to cause charging or discharging between the first battery 110 and the second battery 120.

For example, the first battery 110 may start increasing in temperature upon the start of charging the first battery 110, and the amount of electric power suppliable to the system may increase as time proceeds.

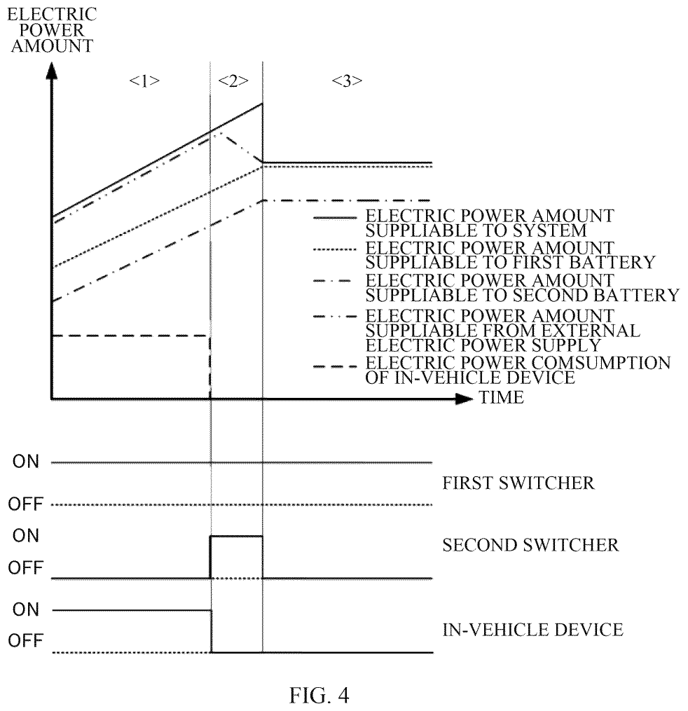

In an example illustrated in FIG. 4, when the air conditioner as the in-vehicle device 150 is in the ON state (refer to <1> in FIG. 4), the amount of electric power suppliable to the system may be the necessary electric power amount that is a sum total of the amount of electric power necessary for the system and the amount of electric power necessary to maintain the operation state of the air conditioner as the in-vehicle device 150.

Accordingly, the system may be supplied with the amount of electric power that is equal to the necessary electric power amount from the external electric power via the charger 140.

Thereafter, when the air conditioner as the in-vehicle device 150 is switched from the ON state to the OFF state, the amount of electric power necessary to maintain the operation state of the air conditioner as the in-vehicle device 150 may become zero. As a result, the necessary electric power amount described above may decrease, and the amount of electric power to be supplied to the system may exceed the amount of electric power necessary for the system.

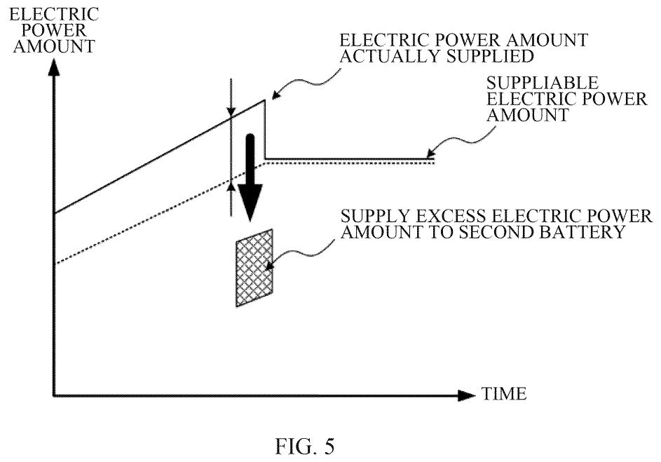

To address this, the excess electric power is supplied to the second battery 120 by switching the second switcher 180 to the ON state. This helps to prevent the first battery 110 from being overcharged (refer to <2> of FIGS. 4 and 5).

Thereafter, when the amount of electric power to be supplied to the first battery 110 becomes equal to the amount of electric power necessary for the system, the second switcher 180 may be switched from the ON state to the OFF state (refer to <3> of FIG. 4 and FIG. 5).

That is, the switching processor 513 supplies the external electric power to the first battery 110 via the charger 140, based on the necessary electric power amount calculated by the necessary-electric-power-amount calculator 511. Further, when the operation state determiner 512 determines that the in-vehicle device 150 has been activated (refer to <1> of FIG. 4) and thereafter switched from the operation state to the non-operation state (refer to <2> of FIG. 4) while the first battery 110 is being supplied with the external electric power via the charger 140, the switching processor 513 performs switching control of switching the second switcher 180 to the closed state to supply the amount of electric power that is equal to the amount of electric power necessary to activate the in-vehicle device 150 to the second battery 120.

Although the second switcher 180 is switched to the closed state when the in-vehicle device 150 is switched from the operation state to the non-operation state, the first battery 110 is prevented from discharging the electric power to the second battery 120 because the first battery 110 has been supplied with the amount of electric power suppliable to the first battery 110.

### <Processing to be Performed by Vehicle Control Apparatus 1>

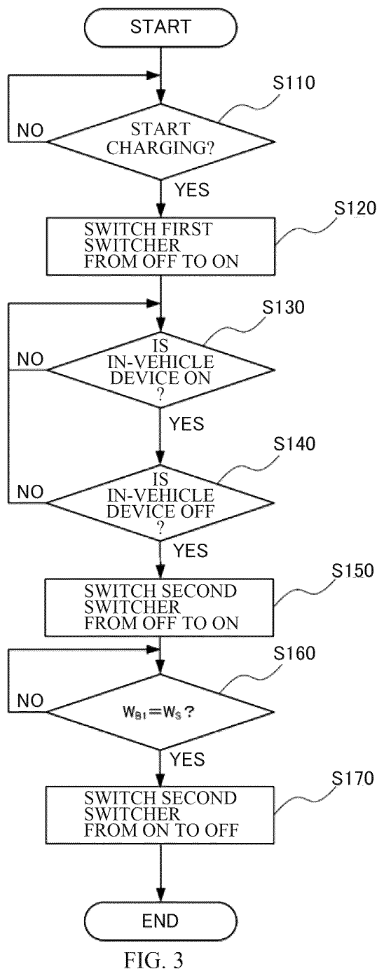

A description will be given, with reference to FIG. 3, of the processing to be performed by the vehicle control apparatus 1 of the present example embodiment.

The control processor 500 may determine whether a charging operation via the charger 140 has been started (Step S110).

If the control processor 500 determines that the charging operation via the charger 140 has not been started (Step S110: NO), the processing may transit to a stand-by mode.

If the control processor 500 determines that the charging operation via the charger 140 has been started (Step S110: YES), the processing may proceed to Step S120.

At this time, the control processor 500 may send the switching processor 513 a control signal to switch the first switcher 160 from the decoupled state to the coupled state.

When receiving the control signal to switch the first switcher 160 from the decoupled state to the coupled state, the switching processor 513 may execute the control of switching the first switcher 160 from the decoupled state to the coupled state (Step S120).

Thereafter, the control processor 500 may determine, based on the result of determination made by the operation state determiner 512, whether the in-vehicle device 150 is in the operation state (Step S130).

If the control processor 500 determines, based on the result of determination made by the operation state determiner 512, that the in-vehicle device 150 is not in the operation state (Step S130: NO), the processing may transit to the stand-by mode.

If determining, based on the result of determination made by the operation state determiner 512, that the in-vehicle device 150 is in the operation state (Step S130: YES), the control processor 500 may determine whether the in-vehicle device 150 is in the non-operation state (Step S140).

If the control processor 500 determines that the in-vehicle device 150 is not in the non-operation state (Step S140: NO), the processing may return to Step S130 and transit to the stand-by mode.

If determining that the in-vehicle device 150 is in the non-operation state (Step S140: YES), the control processor 500 may send the switching processor 513 a control signal to switch the second switcher 180 from the decoupled state to the coupled state.

When receiving the control signal to switch the second switcher 180 from the decoupled state to the coupled state, the switching processor 513 may execute the control of switching the second switcher 180 from the decoupled state to the coupled state (Step S150).

Thereafter, the control processor 500 may determine whether the amount of electric power (W_{B1}) to be supplied to the first battery 110 is equal to the amount of electric power (W_{S}) necessary for the system (Step S160).

If the control processor 500 determines that the amount of electric power (W_{B1}) to be supplied to the first battery 110 is not equal to the amount of electric power (W_{S}) necessary for the system (Step S160: NO), the processing may transit to the stand-by mode.

If determining that the amount of electric power (W_{B1}) to be supplied to the first battery 110 is equal to the amount of electric power (W_{S}) necessary for the system (Step S160: YES), the control processor 500 may send the switching processor 513 a control signal to switch the second switcher 180 from the coupled state to the decoupled state.

When receiving the control signal to switch the second switcher 180 from the coupled state to the decoupled state, the switching processor 513 may execute the control of switching the second switcher 180 from the coupled state to the decoupled state (Step S170).

Thereafter, the control processor 500 may end the processing.

### <Workings and Effects>

As described above, the vehicle control apparatus 1 of the present example embodiment includes the first battery 110, the second battery 120, the first switcher 160 and the second switcher 180, and the control processor 500. The first switcher 160 and the second switcher 180 are configured to make a switchover of a destination to be supplied with external electric power between the first battery 110 and the second battery 120. The control processor 500 includes the necessary-electric-power-amount calculator 511, the operation state determiner 512, and the switching processor 513. The necessary-electric-power-amount calculator 511 is configured to, when the external electric power is to be supplied, calculate the necessary electric power amount that is the sum total of the amount of electric power suppliable to the first battery 110 and the amount of electric power necessary to activate the in-vehicle device 150. The operation state determiner 512 is configured to determine the state of operation of the in-vehicle device 150. The switching processor 513 is configured to control the switchover between the first switcher 160 or the second switcher 180. The control processor 500 is configured to supply the external electric power to the first battery 110, based on the necessary electric power amount. When the in-vehicle device 150 is activated and switched from the operation state to the non-operation state while the first battery 110 is being supplied with the external electric power, the control processor 500 controls the first switcher 160 or the second switcher 180 and supplies the amount of electric power that is equal to the amount of electric power necessary to activate the in-vehicle device 150, from the external electric power to the second battery 120.

That is, when the external electric power is to be supplied, the control processor 500 supplies the external electric power to the first battery 110, based on the necessary electric power amount.

When the in-vehicle device 150 is switched from the operation state to the non-operation state while the first battery 110 is being supplied with the external electric power, the control processor 500 controls the first switcher 160 or the second switcher 180 and supplies the amount of electric power that is equal to the amount of electric power necessary to activate the in-vehicle device 150, from the external electric power to the second battery 120.

Accordingly, it is possible to supply the first battery 110 with the amount of electric power that is the sum total of the amount of electric power suppliable to the first battery 110 and the amount of electric power suppliable to the in-vehicle device 150 from a viewpoint of charging efficiency as in an existing technique, and further prevent the first battery 110 from being supplied with the amount of electric power greater than the acceptable electric power amount of the first battery 110 when the in-vehicle device 150 is switched from the operation state to the non-operation state.

Further, as illustrated in FIG. 5, the control processor 500 is configured to, when the in-vehicle device 150 is in the operation state, supply the second battery 120 with the amount of electric power calculated by subtracting the amount of electric power to be supplied to the first battery 110 from the amount of electric power supplied from the external electric power.

This makes it possible to supply the first battery 110 and the second battery 120 with a maximum electric power amount suppliable to the first battery 110 and the second battery 120, despite the fluctuation of the electric power consumption of the in-vehicle device 150.

In the above-described example embodiments, the in-vehicle device 150 may be an air conditioner.

The air conditioner as the in-vehicle device 150 may be used frequently around the year and consume a large amount of electric power.

Such an air conditioner, which is used frequently and consumes a large amount of electric power, may be greater in the necessary electric power amount and greater in the difference in the electric power amount between in the ON state and in the OFF state, than another type of the in-vehicle device 150.

Accordingly, the vehicle control apparatus 1 of the above-described example embodiment is effective for a case where the in-vehicle device 150 is an air conditioner.

In some embodiments, a program that causes the process to be performed by the processor 510 may be recorded on a non-transitory recording medium readable by a computer system. The vehicle control apparatus 1 according to the example embodiment of the disclosure may be implemented by causing a memory of the computer system to load the program recorded in the non-transitory recording medium into the processor 510 and causing the computer system to execute the program.

The “computer system” as used herein may encompass an operating system (OS) and hardware such as a peripheral device.

The “computer system” may encompass a website providing environment or a website displaying environment when the computer system utilizes a World Wide Web (WWW) system.

The program may be transmitted from the computer system that contains the program in a device such as a storage device to another computer system via a transmission medium or by a carrier wave in a transmission medium.

The “transmission medium” designed to transmit the program may refer to a medium having a capability to transmit data, including: a network or a communication network such as the Internet; and a communication link or a communication line such as a telephone line.

The program may be directed to implement a part of the operation described above.

The program may be a so-called differential file or differential program designed to implement the operation by a combination of the program already recorded on the computer system.

Although some embodiments of the disclosure have been described in detail with reference to the accompanying drawings, all vehicles implementable through design modifications appropriately made by those skilled in the art based on the vehicles according to the foregoing example embodiments of the disclosure also fall within the scope of the disclosure as long as they include the gist of the disclosure.

Those skilled in the art can conceive of various modifications and alterations within the scope of the inventive concept of the disclosure, and it is understood that these modifications and alterations also fall within the scope of the disclosure.

For example, those skilled in the art may add some constituent elements to, delete some constituent elements from, or make some design modifications to the foregoing example embodiments as appropriate, or add some steps to, remove some steps from, or make some modifications to conditions of the foregoing example embodiments as appropriate. These embodiments are also included in the scope of the disclosure as long as they include the gist of the disclosure.

Further, it will be understood that other workings and effects than those provided by the foregoing example embodiments and apparent from the description herein or appropriately conceivable by those skilled in the art are naturally provided by the disclosure.

Various embodiments of the disclosure may be provided by appropriately combining the constituent elements disclosed in the foregoing example embodiments.

For example, some constituent elements may be deleted from all the constituent elements disclosed in the foregoing example embodiments.

Furthermore, constituent elements across different embodiments may be combined as appropriate.

As used in this specification and the appended claims, the singular forms “a”, “an”, and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

The control processor 500 illustrated in FIGS. 1 and 2 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the control processor 500 illustrated in FIGS. 1 and 2. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the control processor 500 illustrated in FIGS. 1 and 2.

1. A vehicle control apparatus comprising:
a switcher configured to make a switchover of a destination to be supplied with external electric power between a first battery and a second battery; and
a control processor comprising
a necessary-electric-power-amount calculator configured to, when the external electric power is to be supplied to the destination, calculate a necessary electric power amount that is a sum total of an amount of electric power suppliable to the first battery and an amount of electric power necessary to activate an in-vehicle device,
an operation state determiner configured to determine a state of operation of the in-vehicle device, and
a switching processor configured to control the switchover to be made by the switcher, wherein
the control processor is configured to
supply the external electric power to the first battery, based on the necessary electric power amount, and
when the in-vehicle device is switched from an operation state to a non-operation state while the first battery is being supplied with the external electric power, control the switcher and supply an amount of electric power that is equal to the amount of electric power necessary to activate the in-vehicle device, from the external electric power to the second battery.

2. The vehicle control apparatus according to claim 1, wherein the in-vehicle device comprises an air conditioner.

3. A vehicle control apparatus comprising:
a first battery;
a second battery;
a switcher configured to make a switchover of a destination to be supplied with external electric power between the first battery and the second battery; and
a control processor comprising
one or more processors, and
one or more memories communicably coupled to the one or more processors, wherein
the one or more processors are configured to,
when the external electric power is to be supplied to the destination, calculate a necessary electric power amount that is a sum total of an amount of electric power suppliable to the first battery and an amount of electric power necessary to activate an in-vehicle device,
supply the external electric power to the first battery, based on the necessary electric power amount, and
when the in-vehicle device is activated and switched from an operation state to a non-operation state while the first battery is being supplied with the external electric power, control the switcher and supply an amount of electric power that is equal to the amount of electric power necessary to activate the in-vehicle device, from the external electric power to the second battery.
